(19) United States
(12) Patent Application Publication
(10) Pub. No.: US 2020/0110794 A1
(43) Pub. Date: Apr. 9, 2020

(54) EMOJI MODIFICATION

(71) Applicant: International Business Machines Corporation, Armonk, NY (US)

(72) Inventors: Eienne E. Vos, Johannesburg (ZA); Ashley D. Gritzman, Johannesburg (ZA); Zaahid Kara, Johannesburg (ZA); Toby Kurien, Johannesburg (ZA); Matokollo Magadla, Johannesburg (ZA); Komminist Weldermariam, Nairobi (KE)

(21) Appl. No.: 16/150,296

(22) Filed: Oct. 3, 2018

(51) Int. Cl. G06F 17/24; G06F 17/27; G06T 11/60; H04L 12/58

(52) U.S. Cl. CPC G06F 17/24; G06F 17/2785; G06F 17/2765; H04L 51/04; G06T 11/60

(57) ABSTRACT

A computer-implemented method for emoji modification, as well as a corresponding system and a corresponding computer program product, are disclosed. An intended meaning associated with an emoji, which has been selected by a sender for transmission to a receiver, is established. An interpretation of the emoji by the receiver is predicted. The established intended meaning is compared with the predicted interpretation and the comparison is used to determine whether emoji modification is required. In response to determining that emoji modification is required, at least one aspect of the emoji is modified better to align the intended meaning of the sender with the predicted interpretation of the emoji by the receiver.

### BACKGROUND

The present disclosure relates to emojis and it relates specifically to a computer-implemented method for emoji modification.

### SUMMARY

According to an example embodiment of the present disclosure, there is provided a computer-implemented method comprising establishing, by a sender analysis module, an intended meaning associated with an emoji which has been selected by a sender for transmission to a receiver. The method may comprise predicting, by a receiver analysis module, an interpretation of the emoji by the receiver. The method may comprise comparing, by a comparison module, the established intended meaning with the predicted interpretation. The comparison between the established intended meaning and the predicted interpretation may be used to determine whether emoji modification is required. The method may further comprise modifying, by an emoji modification module, at least one aspect of the emoji, in response to a determination that emoji modification is required.

Example embodiments of the present disclosure extend to a corresponding system and to a corresponding a computer program product.

### BRIEF DESCRIPTION OF THE DRAWINGS

FIG. 1 illustrates an example of different renderings of a certain emoji on different devices and platforms;

FIG. 2 illustrates a network topology comprising an example of a computer system for emoji modification, in accordance with an embodiment of the disclosure;

FIG. 3 illustrates a flow diagram of an example of a method of emoji modification, in accordance with an embodiment of the disclosure;

FIG. 4 illustrates an example of a screenshot of an electronic message which includes a plurality of emojis;

FIG. 5 illustrates a schematic diagram which depicts the functioning of an example of a metadata module, in accordance with an embodiment of the disclosure;

FIG. 6 illustrates a flow diagram which depicts the functioning of an example of a sender analysis module, in accordance with an embodiment of the disclosure;

FIG. 7 illustrates a flow diagram which depicts the functioning of an example of a receiver analysis module, in accordance with an embodiment of the disclosure;

FIG. 8 illustrates a flow diagram which depicts the functioning of an example of a comparison module, in accordance with an embodiment of the disclosure;

FIG. 9 illustrates a flow diagram which depicts the functioning of an example of an emoji modification module, in accordance with an embodiment of the disclosure;

FIG. 10 illustrates, by way of example screenshots, the result of the modification of emojis in an electronic message in accordance with an embodiment of the disclosure;

FIG. 11 illustrates an example of a screenshot of a sender's user interface, wherein a reference module according to an embodiment of the disclosure is employed;

FIG. 12 illustrates another example of a screenshot of a sender's user interface, wherein a reference module according to an embodiment of the disclosure is employed; and

FIG. 13 illustrates a schematic view of functional components of examples of an emoji modulating computer system, emoji contextualizing manager and emoji modification system, which may be utilized in embodiments of the disclosure.

### DETAILED DESCRIPTION

Emojis (sometimes also called emoticons) have become an important part of electronic communication for many people. Emojis may be small icons, pictures or pictograms used in messaging and other forms of communication. Emojis may be used to express an idea or emotion. It has been found that different people have different reactions to and/or interpretations of some emojis. For instance, it has been found that a certain emoji depicting a face with tears may be interpreted either positively, e.g., as “tears of joy”, or negatively, e.g., as “tears of sorrow”.

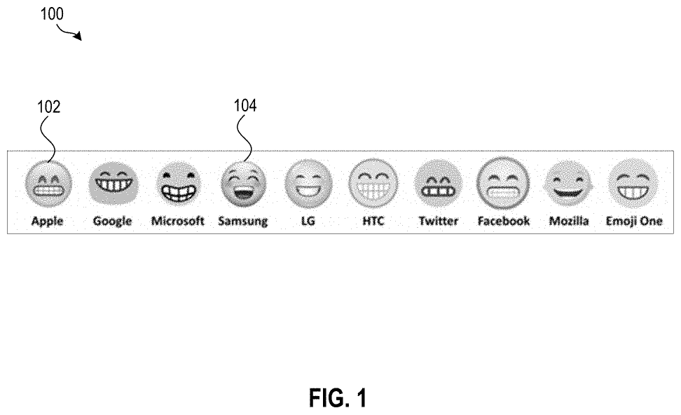

Emojis may be rendered differently by different devices, messaging and/or operating platforms, resulting in differences in interpretation and/or reaction. Referring to the screenshot 100 in FIG. 1, as an example, consider the way in which the same emoji, in this case the “grinning face with smiling eyes” emoji, may be rendered differently by various well-known devices and platforms. It has been found that the rendering of this emoji by an Apple™ device 102 may have a neutral or slightly negative sentiment associated therewith, while the sentiment associated with the rendering of this emoji by a Samsung™ device 104 may be positive, and in some cases strongly positive. This may present a risk of miscommunication. For instance, if a sender types “Just went on that date!” on a Samsung™ device, adds the emoji 104 and transmits the electronic message to a receiver with an Apple™ device, the receiver will see the emoji 102. The receiver may interpret the message as meaning that the sender's date did not go very well, while the sender in fact means that the date did go well.

A person's interpretation of an emoji may be influenced by various factors, such as his or her culture, history, age, location, religion, etc. The profile and/or context of the sender or receiver may play a significant role in what an emoji means and how it is interpreted. For instance, consider how different emojis may be used to signify greetings around the world, e.g., a waving hand, folded hands, a face with a tongue sticking out, and clapping hands. Also consider the following examples:
A “thumb up” emoji may be interpreted by many as a sign of approval or agreement. However, for receivers with certain profiles/contexts this emoji may be interpreted as an insult or may be generally offensive.
A “finger indicating come here or come over” emoji may be interpreted by many as a sign or request to come forward or to come over, while in some parts of the world this gesture may be used to request dogs to steps forward. This emoji may thus be insulting to certain receivers.
A “look at wristwatch” emoji may be interpreted by many as a sign that a person is in a rush and may not be judged as offensive. However, in certain cultures, once a conversation has been started, it is understood that the conversation has to proceed and end naturally, and this emoji may be insulting to persons of these cultures.

Embodiments of the disclosure provide an emoji modification method and/or an associated system. The method may be used to modify an emoji selected by a sender, in order to ensure, or attempt to ensure, that the intended meaning of the emoji selected by the sender is properly conveyed when the emoji is rendered at the receiver. The method may ensure, or attempt to ensure to a degree, that the essence of the sender's intention is preserved while facilitating understanding on the part of the receiver. Emoji modification according to embodiments of the disclosure may be carried out in various ways, as will be described in greater detail in what follows.

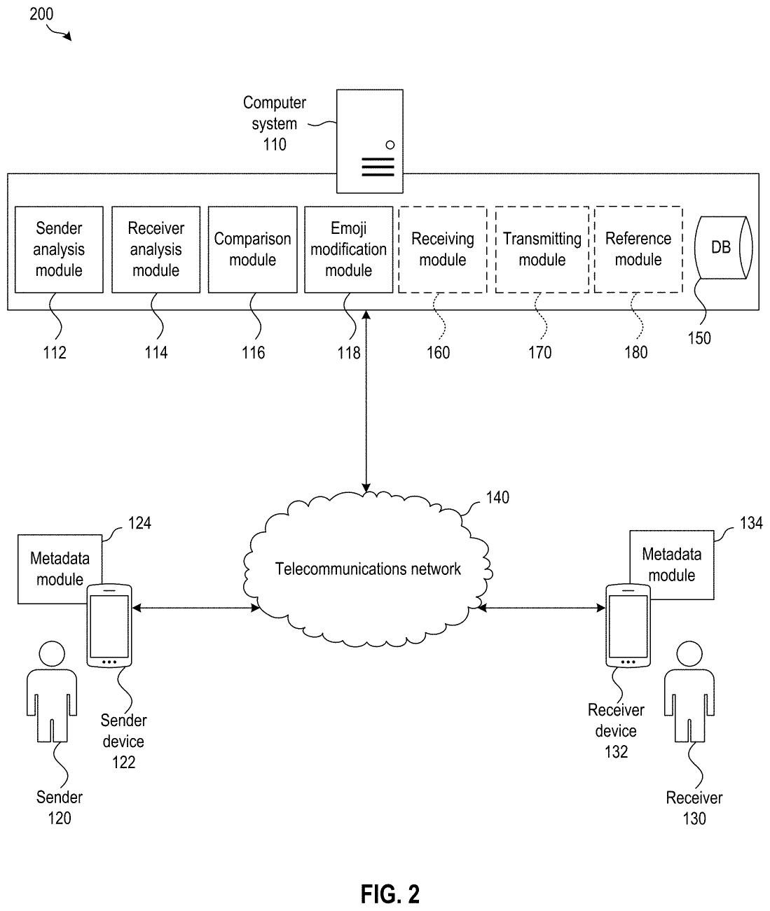

The topology 200 of FIG. 2 includes a computer system 110 for emoji modification. The computer system 110 may be in the form of a server, e.g., a remotely accessible server, including one or a plurality of computer processors and one or a plurality of computer readable media with program instructions stored thereon. When executing the program instructions, the computer processor(s) may provide for the following functional modules: a sender analysis module 112, a receiver analysis module 114, a comparison module 116 and an emoji modification module 118. The computer system 110 of FIG. 2 may further include a database 150.

In this embodiment, the sender analysis module 112 is configured to establish an intended meaning associated with an emoji which has been selected by a sender 120 for transmission to a receiver 130. The receiver analysis module 114 is, in this embodiment, configured to predict an interpretation of the emoji by the receiver 130.

The comparison module 116 may be configured to compare the established intended meaning with the predicted interpretation and to determine whether emoji modification is required based on this comparison. The emoji modification module 118 may be configured to modify at least one aspect of the emoji in response to a determination that emoji modification or predicted emoji modification is required.

The sender 120 may be in possession of a sender device 122 by which it can communicate with a receiver device 132 associated with the receiver 130. The sender device 122 and receiver device 132 may be any suitable type of communication device(s). In the example embodiment of FIG. 2, the devices 122, 132 are both smartphones allowing the sender 120 and receiver 130 to communicate via a telecommunications network 140. The computer system 110 may be remotely and wirelessly connected to the telecommunications network 140.

The sender device 122 and receiver device 132 may each have a mobile software application installed thereon, providing each device 122, 132 with the ability to participate in an emoji modification service as described herein. The software application may provide a functional module in the form of a metadata module 124, 134. The metadata module 124 of the sender device 122 may be configured to obtain and/or store contextual and/or profile information associated with the sender 120 which may be used to interpret the (predicted) intended meaning of a message and/or emoji transmitted by the sender 120. Likewise, the metadata module 134 of the receiver device 132 may be configured to obtain and/or store contextual and/or profile information associated with the receiver 130 which may be used to predict the receiver's interpretation of a message and/or emoji transmitted to the receiver 130, e.g., by the sender 120.

In the example embodiment of FIG. 2, the modules 112, 114, 116, 118 form part of and/or are functionally provided by the computer system 110. However, it will be appreciated that in other embodiments one or more of these modules 112, 114, 116, 118 may be provided by one or both of the sender device 122 and the receiver device 132, in use, e.g., by a mobile software application installed on such a device. Similarly, the metadata modules 124, 134 may, in other embodiments, form part of or be functionally provided by the computer system 110. The metadata module 124 may, in other embodiments, form part of the sender analysis module 112 and the metadata module 134 may, in other embodiments, form part of the receiver analysis module 114. The functionality of the sender analysis module 112 and the receiver analysis module 114 may be implemented by a single module in alternative embodiments of the disclosure.

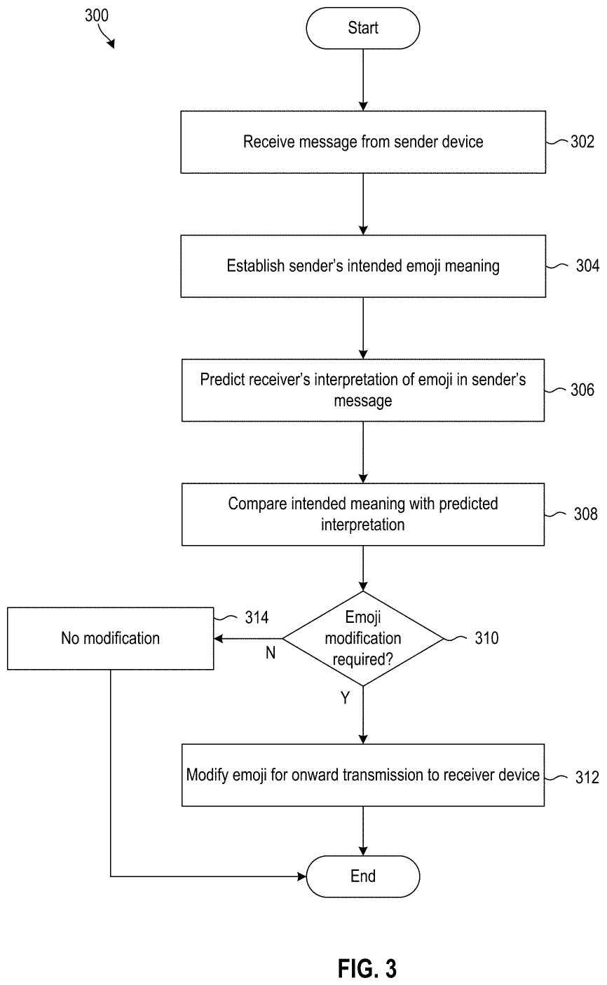

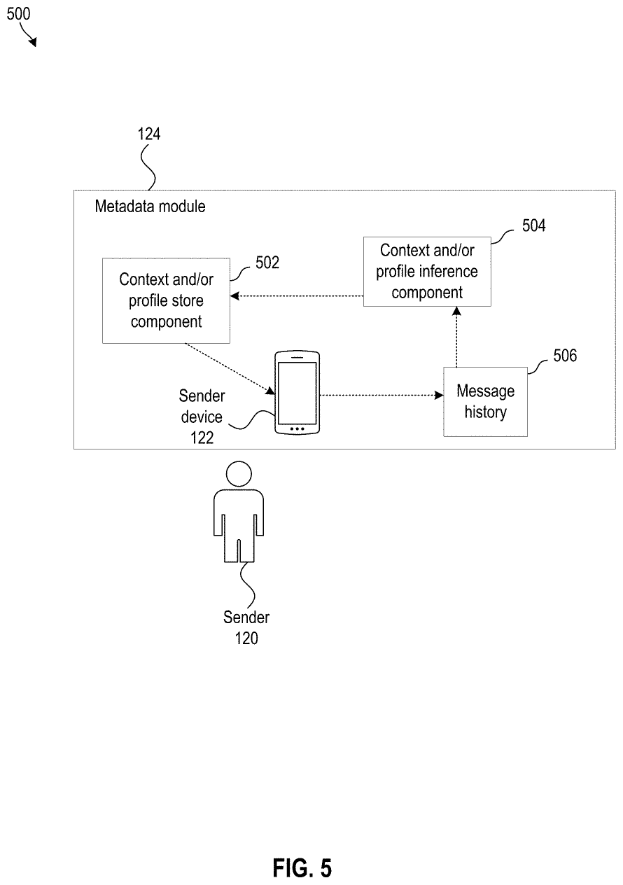

Referring now to FIG. 3, the flow diagram 300 illustrates an example of a method of emoji modification, which may be implemented using the computer system 110 and other components described with reference to FIG. 2. FIG. 3 is intended to provide an overview of such an example method, while more detailed explanations are included with reference to FIGS. 5 to 9.

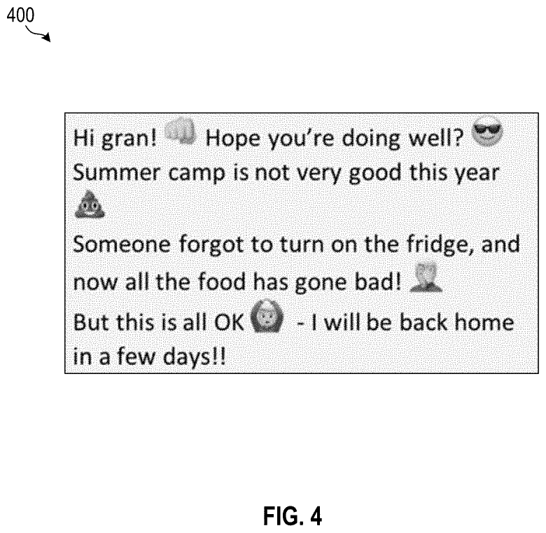

At a first stage 302, the computer system 110 may receive, via the network 140, an electronic message sent by the sender 120 from the sender device 122. The computer system 110 may be configured to analyze the message to determine whether emoji modification is required prior to transmitting the message onward to the receiver device 132. The electronic message in the screenshot 400 in FIG. 4 is used as an example electronic message herein. The electronic message 400 includes text and emojis which the sender 120 may wish to send to the receiver 130 using the sender device 122. For exemplary purposes, the sender 120 may be a boy of 13 years old (“Adam”) and the receiver 130 may be his grandmother (“Gwen”), who is 75 years old. The sender 120 transmits the message 400 to tell his grandmother about his experience being at summer camp.

The sender analysis module 112 may be used to establish the intended meaning of one or each emoji in the electronic message (stage 304). In this context, “intended meaning” refers to the meaning, sentiment or message the sender 120 wishes to convey with a particular emoji. Data from the metadata module 124 and/or the database 150 may be used in establishing this intended meaning.

The receiver analysis module 114 may be used to predict the receiver's interpretation of one or each emoji in the electronic message 400 (stage 306). In this context, the “receiver's interpretation” refers to the manner in which the receiver 130 is likely to interpret a particular emoji and/or the sentiment or meaning which is likely to be attached to the emoji by the receiver 130. Data from the metadata module 134 and/or the database 150 may be used for the purpose of predicting this interpretation.

Stages 304 and 306 of the flow diagram 300 need not necessarily be conducted in a particular sequence and in some embodiments they may be conducted substantially simultaneously.

At a next stage 308, the comparison module 116 may then be used to compare the established intended meaning (e.g., the sender's probable intention with each emoji) with the predicted interpretation (e.g., the receiver's probable interpretation of each emoji).

If, at stage 310, it is determined that there is a difference (e.g., a significant or predefined difference) between the established intended meaning and the predicted interpretation, at least one aspect of the emoji may be modified (stage 312). On the other hand, if the comparison returns a match or indicates that there is no significant or predefined difference between the intended meaning and the predicted interpretation, the emoji may be left unchanged (stage 314).

The above stages may be conducted simultaneously or successively for each emoji in the electronic message in question.

The diagram 500 of FIG. 5 conceptually illustrates the functioning of the metadata module 124, according to an embodiment. FIG. 5 illustrates the metadata module 124 of the sender device 122, but it will be appreciated that the metadata module 134 of the receiver device 132 may function in a similar manner in relation to the receiver 130, at least in some embodiments of the disclosure. Comments made in regard to the sender 120 with reference to FIG. 5 may therefore, were appropriate, apply equally to the receiver 130 in the context of the functioning of the metadata module 134 of the receiver device 132.

The metadata module 124 may include a context and/or profile store component 502 and a context and/or profile inference component 504. The context and/or profile store component 502 may be configured to store profile information and contextual information concerning the sender 120 that may be used by the computer system 110 for modifying emojis. In other words, the metadata module 124 may store data relating to a sender profile and/or data relating to a sender context. The sender profile may include personal data concerning the sender 120 and the sender context may include contextual data relevant to the sender 120.

As an example, the sender profile and/or sender context may include, but are not limited to:
Name, e.g., John Smith;
Gender identification, e.g., Male, Female, Non-Binary, He/Him or She/Her;
Age or age range, e.g., 20 to 30 years;
Device and/or messaging or operating platform (or version of operating platform) relevant to how emojis render on devices in question, e.g., Apple iPhone™, Desktop Linux™ or Samsung™ tablet device;
Temporal context;
Geospatial context;
Reaction types, e.g., gestures;
Cognitive properties or cognitive state, e.g., message tone;
Sub-culture/language style, e.g. “Leet speak” or “Corporate Professional”; and/or
Mood, e.g., playful or irritated.

Some profile and/or context data may be provided directly by the sender 120, e.g., name or age may be provided by way of user input. Data or information may also be inferred by the context and/or profile inference component 504, if the sender 120 has not entered this information already. This may be done by machine learning and/or statistical analysis of the sent and received message history 506 for the sender 120. As an example, continued use of abbreviated text, e.g., “18, c u b4 7” which translates as “I am late, see you before seven”, may possibly be an indication of an age range between 10 and 20. Multiple received messages starting with “Hi Mary” may allow the context and/or profile inference component 504 to infer the sender's name as “Mary”. If recent sent messages contained words like “argh” or emojis of angry faces, the context and/or profile inference component 504 may mark the mood as “Angry”. Aspects of the sender profile and/or sender context may be dynamic.

Context data and profile data of the sender 120 and the receiver 130 may be obtained in a number of different ways by the metadata modules 124, 134 and/or the analysis modules 112, 114. Examples of data sources which may be analyzed or obtained include, but are not limited to:
Historical usage and/or interpretation of emojis in a given context, by the sender 120, receiver 130 and/or a cohort of users;
Historical cognitive properties of the sender 120/receiver 130 in response to emojis (e.g., reactions, mood or emotional state);
Existing obtainable user profiles (e.g., location, race, culture, ethnicity, religion, language, age, gender, job classification, historical reactions, engagement, interpretation of emojis, etc.);
Current and previous activities of the sender 120/receiver 130 (e.g., typing an email, browsing the internet, watching videos or listening to music);
Previously learned reactions, engagements, or interpretations of emojis, analysis of historical feedbacks etc. of the sender or receiver;
Data from sensors of the sender device 122 or receiver device 132, or other related devices, including historical responses or interactions to an emoji, feedback to an emoji provided by the sender 120, receiver 130 and/or a cohort of users, and historical communication means (e.g., Facebook™, WhatsApp™, SMS, email); and/or
Previously learned cognitive states of the sender 120/receiver 130, previously used emoji adjustment factors and strategies, and real-time analysis instrumented data obtained by the sender device 122 or receiver device 132, or other related devices.

The above data may be learned by the system 110 or may be obtained from another source.

The sender profile and context, the receiver profile and context, and/or other data associated therewith, may be stored locally (e.g., on the device 122, 132) or on remotely hosted databases, e.g., the database 150 or an associated cloud storage system.

The metadata modules 124, 134 may therefore be used to establish, and in some cases to update, the context and profile of both the sender 120 and the receiver 130. This may include any attributes that may have an influence on how either party intends and perceives message content and how emojis are interpreted.

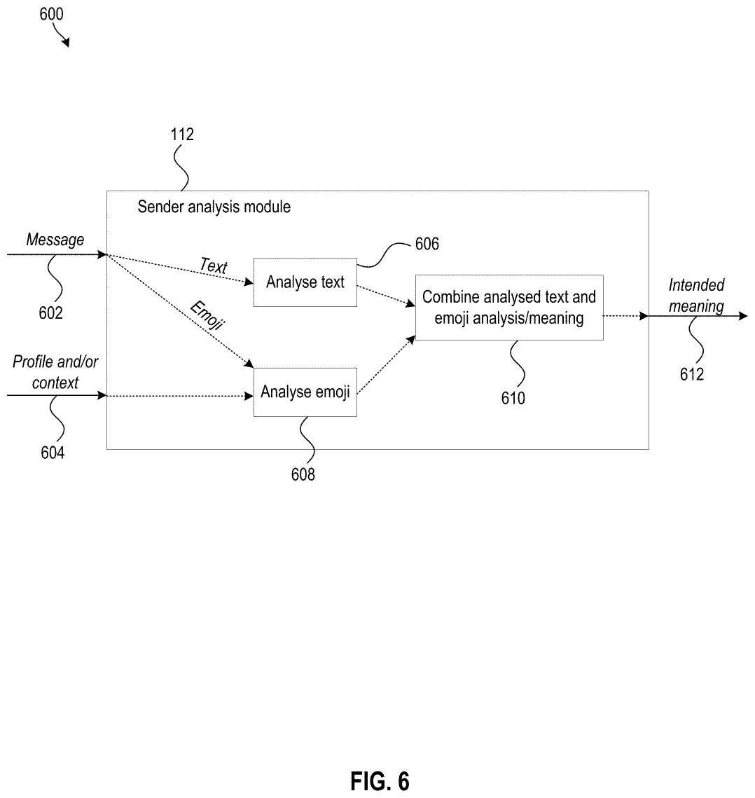

The diagram 600 of FIG. 6 conceptually illustrates the functioning of the sender analysis module 112, according to an embodiment. The sender analysis module 112 operatively receives, as inputs, an electronic message 602 and the sender profile and/or sender context 604.

The input message may include text and one or more emojis. In some cases, however, the input may be an emoji only. The sender analysis module 112 may analyze text in order to extract the sentiment and intended meaning from the text (606), e.g., by parsing the text. In this example, this may be done by way of machine learning, artificial intelligence, natural language processing (NLP), or the like. The sender analysis module 112 may further analyze the emoji or emojis in the message (608) to determine the meaning the sender 120 links to the emoji or emojis.

It will be appreciated that establishing the intended meaning of the sender may refer to establishing the intended meaning with a certain degree of certainty and not necessarily definitively.

The text and/or emoji(s) may be analyzed and interpreted based on the sender profile and/or the sender context. The sender analysis module 112 may use profile data and context data obtained from the metadata module 124 in this regard. The sender analysis module 112 may also use additional data, e.g., a lookup table that provides the typical meaning attributed to a particular emoji by a person of a certain age group.

The sender analysis module 112 may further be configured to analyze a conversation context, and in particular a current conversation context. Alternatively, conversation context data may be obtained from an external module or component. For instance, the module 112 may apply a custom trained NLP model to determine the sentiment of the emoji in a message (e.g., positive, negative or neutral) and/or may analyze the current conversation between the sender 120 and the receiver 130 in order to determine characteristics of the current conversation (e.g., stressful, intense or relaxed). In some embodiments, the sentiment of the emoji in the message together with the characteristics of the conversation may form the current conversation context.

In some embodiments, audio and/or video input may be used to determine the emotional state of the sender 120. For example, if the sender 120 is feeling happy, and perhaps smiling, then this may be recorded as part of the sender profile or sender context for the purposes of determining the intended meaning of an emoji.

The analysis of the text and emoji(s) may be combined (610) in order to arrive at an intended meaning (612).

As an example of the functioning of the module 112, consider the following sentence from the message 400 in FIG. 4: “Someone forgot to turn on the fridge, and now all the food has gone bad!*facepalm emoji*” In this case, the module 112 may determine that the facepalm emoji conveys Adam's frustration and disappointment with this statement about someone that forgot to turn on the fridge, which led to the food going bad. Furthermore, analysis of the text may result in negative sentiment being detected. Accordingly, the intended meaning (612) output by the sender analysis module 112 may be that the emoji should be interpreted negatively, as expressing frustration, disappointment and embarrassment.

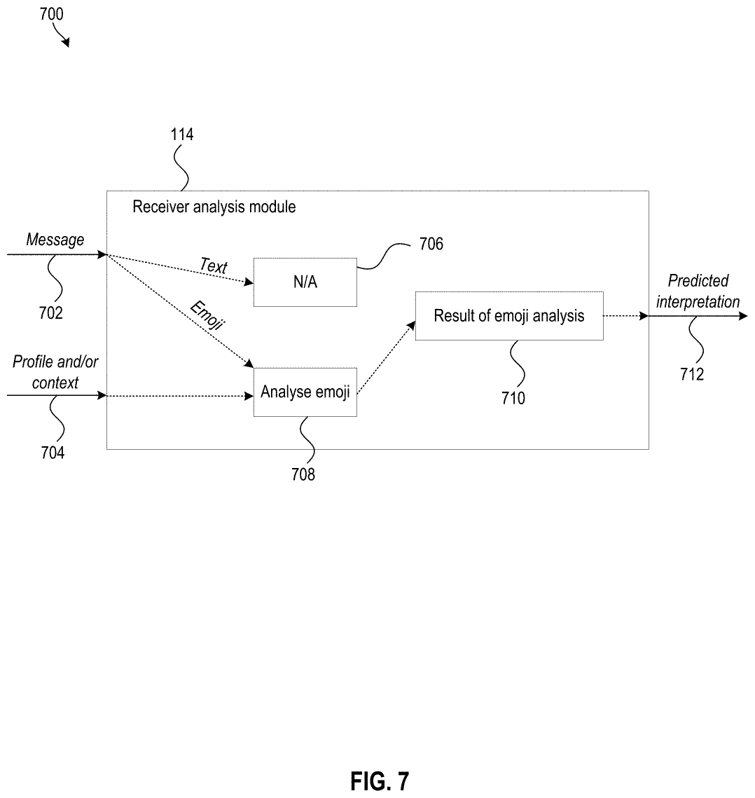

The diagram 700 of FIG. 7 conceptually illustrates the functioning of the receiver analysis module 114, according to an embodiment. The receiver analysis module 114 operatively receives, as inputs, an electronic message 702 and the receiver profile and/or receiver context 704.

The receiver analysis module 114 may aim to determine how the receiver 130 may interpret the use of an emoji. In this example, the receiver analysis module 114 does not analyze the text in the message and analyses only the emoji(s) (706). In other embodiments, the receiver analysis module 114 may also analyze text in a manner similar to the manner described with reference to FIG. 6.

The receiver analysis module 114 analyses each emoji based on the receiver profile and/or the receiver context (708). The module 114 may use profile data and context data obtained from the metadata module 134 in this regard. The receiver analysis module 112 may also use additional data, e.g., a lookup table that provides the typical interpretation of a particular emoji by a person of a certain age group.

The receiver analysis module 114 may further be configured to analyze the conversation context and/or obtain conversation context data from an external module or component. Based on the analysis of the current context of the emoji, the module 114 may determine, predict or measure the difficulty in interpreting the intended meaning and/or the degree of sentiment and emotional level of the receiver 130. The receiver analysis module 114 may also, or alternatively, determine or predict a degree of sentiment in response to the emoji in question by the receiver 130, and/or determine a degree of emotional level in response to the emoji in question by the receiver 130.

The result (710) of the emoji analysis conducted by the module 114 yields a predicted interpretation (output, 712). Consider the “facepalm” example used with reference to FIG. 6 above. In this case, among older people, the “facepalm” emoji may be mistaken as someone having a headache or being confused. Accordingly, the receiver analysis module 114 may predict that the emoji will be interpreted by the receiver 130, Gwen, as someone having a headache or being confused.

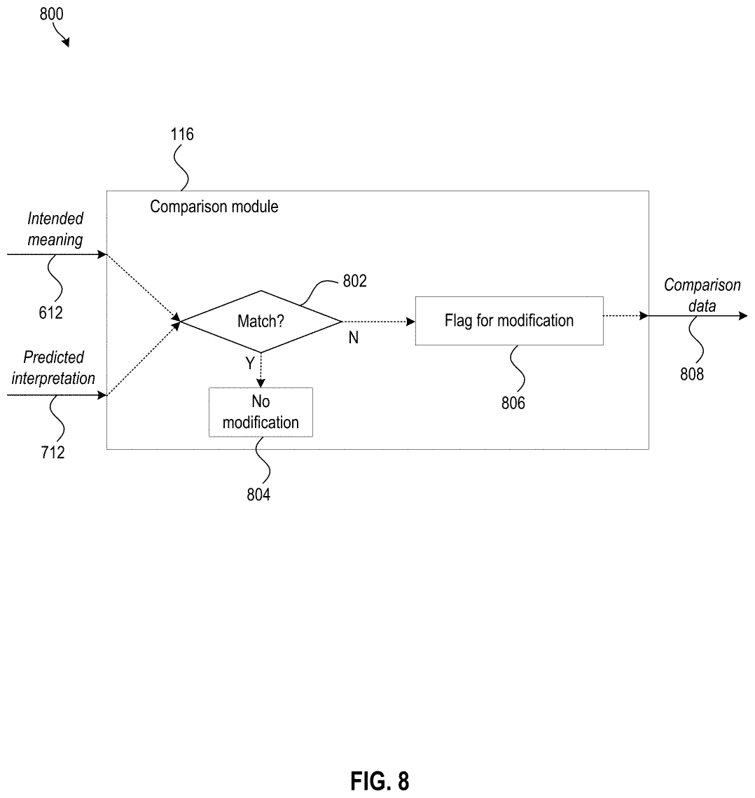

The diagram 800 of FIG. 8 conceptually illustrates the functioning of the comparison module 116, according to an embodiment. The comparison module 116 operatively receives, as inputs, the intended meaning 612 established by the sender analysis module 112 and the interpretation 712 predicted by the receiver analysis module 114.

The module 116 compares these inputs (802) and if there is no significant difference between the two, i.e. if they substantially match, no modification is made (804). On the other hand, if there is a mismatch or difference, e.g., as is the case with the outputs described with reference to the example of FIG. 4, at least an aspect of the emoji in question is flagged for modification (806) and comparison data (808), indicating these discrepancies, is transmitted to the emoji modification module 118.

The comparison module 116 may thus aim to flag possible conflicting meanings and interpretations, based on the profiles and/or contexts of a sender and receiver, to avoid possible misinterpretations.

Consider again, as an example, the message 400 of FIG. 4. The comparison module 116 may flag at least the following emojis for modification:
The “facepalm” emoji may be flagged for the reasons identified above;
The “fist-bump” emoji may have a greeting as an intended meaning, but may have a different predicted interpretation, e.g., being punched;
The “poop/ice cream” emoji may be intended to refer to disgust or dissatisfaction, but may have a different predicted interpretation, e.g., ice cream or yoghurt.

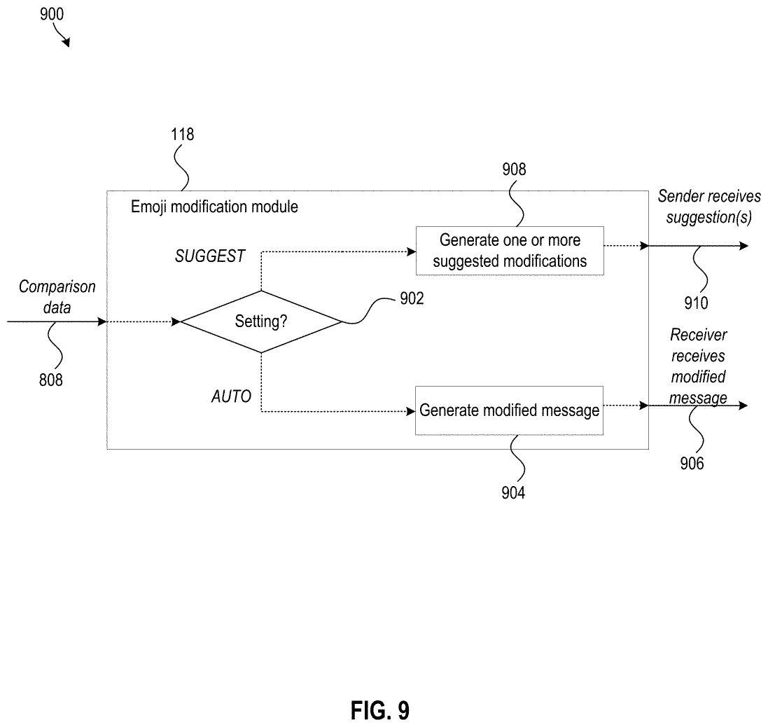

The diagram 900 of FIG. 9 conceptually illustrates the functioning of the emoji modification module 118, according to an embodiment. The emoji modification module 118 operatively receives, as an input, the comparison data (808) from the comparison module 116. The comparison data may merely indicate that modification is required or may instruct the module 118 on how to modify the emoji(s) in question, e.g., by providing appropriate emoji adjustment factors.

Emoji modification or adjustment may be carried out in a number of different ways, including, but not limited to:
substituting the emoji with a more appropriate emoji;
suggesting at least one substitute emoji;
changing one or more features of the emoji;
suggesting changes to one or more features of the emoji;
replacing one or more features of the emoji with more suitable features;
suggesting replacement of one or more features of the emoji with more suitable features;
morphing the emoji;
suggesting morphing of the emoji;
generating or providing an interpretation hint for the emoji;
changing an emoji sequence associated with the emoji; and/or
suggesting a change in an emoji sequence associated with the emoji (embodiments of the disclosure may apply to messages that include a sequence of emojis and one way in which they may be modified is by changing their order).

Hints may be cognitive in that the modules 116 and/or 118 may determine whether the receiver 130 has shown different expressions or reactions (e.g., gesture or gaze detection) in response to past similar emojis.

Essentially, the emoji adjustment module 118 may thus determine or obtain emoji adjustment factors or adjustment suggestions, based on the result of the earlier comparison, and proceed to carry out or suggest a modification accordingly.

In this specific example, the module 118 may check a modification setting (902) associated with the sender 120 to determine whether modification may be carried out automatically or whether modification should be suggested to the sender 120 first. If an “AUTO” setting is selected, the emoji adjustment module 118 may generate a modified electronic message (904), e.g., replace the problematic emojis with more appropriate ones, and may output the modified message which is then received by the receiver 130 on the receiver device 132 (906). Alternatively, if a “SUGGEST” (e.g., not automatic) setting is selected, the emoji adjustment module 118 may first generate one or more suggested modifications (908), and provide the sender 120 with suggestions for approval or possible selection (910).

In some embodiments, if “auto-modification” is not enabled, the adjustment module 118 may simply highlight an emoji that may be problematic to the sender 120 on the sender device 122, with one or more options to guide an auto-correction process. If “auto-modification” is enabled, a potentially problematic emoji may be highlighted, allowing the sender 120 to select or tap the emoji. Tapping the emoji may bring up a correction notification, popup or prompt, explaining why the emoji may be problematic, e.g., it is prone to misinterpretation because the receiver device 132 renders the emoji differently, or it is not appropriate for the receiver's age-group, or it is a known ambiguous emoji, etc. The sender 120 may then select a more appropriate emoji, e.g., from a list, or opt to leave the emoji unchanged. This approach may be beneficial in that it may ensure that the sender 120 remains in control of the sent messages. Thus, even if the inference of the “intended meaning” fails, the sender 120 may be able to take corrective action. Similarly, if the system is running on the receiver device 132, the receiver device 132 may be configured to highlight an incoming emoji as potentially problematic and allow a similar process to unfold in order to clear up potential misunderstandings.

As mentioned above, in some embodiments, the computer system 110 may determine that an emoji will be rendered differently on the receiver device 132, because the receiver device 132 is has a different device type or uses a different messaging or operating platform. Accordingly, the comparison module 116 may determine that the receiver 120 may interpret the emoji differently from the intended meaning which the sender 120 had in mind when selecting the emoji, as a result of such a difference. The emoji modification module may then make a suitable modification to the emoji to ensure that the original meaning or message is preserved.

Due to the large variety of platforms and software packages available in the market, and the resulting variation in the manner in which emojis are rendered, it may be impractical to have a database of various emoji renderings by device or platform. To overcome this, in embodiments of the disclosure, the receiver device 132 may be requested by the computer system 110 to transmit a rendering of the emoji being entered by the sender 120. The emoji may then be replaced in the sender device 122 with the actual rendering of the emoji from the receiver device 132, allowing the sender 120 to preview exactly how the message will look on the receiver device 132, before sending it. If this process is slow, the local emoji of the sender device 122 may display immediately while showing a “loading” animation beside it, and once the receiver device's rendering is received, the local emoji may be replaced with the remotely rendered emoji. This data may be cached for future use. This may also apply to the manner in which the emoji is displayed in the correction notification, popup or prompt as described above, which may make the explanation (such as “ambiguous”) easier to understand.

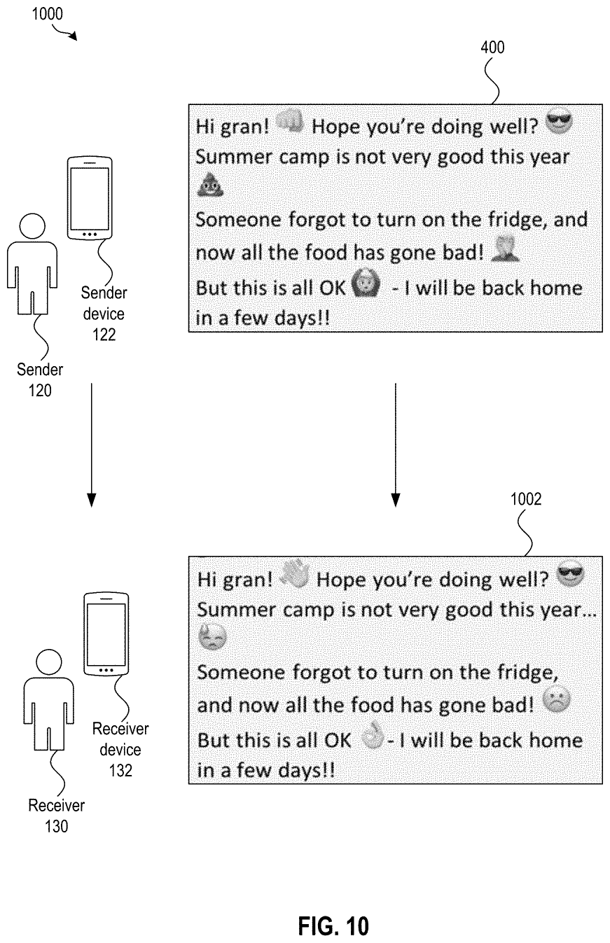

The diagrams 1000 of FIG. 10 illustrate the sender 120, sender device 122, receiver 130 and receiver device 132 of FIG. 2. FIG. 10 also shows the electronic message 400 of FIG. 4 and a result 1002 of the modification of emojis in the electronic message 400 in the manner described above.

In the message 400 sent by the sender 120, Adam, he uses a “fist” emoji for a fist-bump (which he often uses when messaging his friends) as an informal way of greeting (similar to a high-five). He goes ahead to tell the receiver 130, his grandmother, Gwen, that he doesn't like this year's summer camp, using the “poop” emoji as teenagers often do, without thinking how she would interpret this emoji. He uses the “facepalm” emoji to convey his frustration about what happened with all of the food going bad. Finally, using the “man gesturing OK” emoji, he says that everything will be fine, since he will be back home in a few days.

Adam used these emojis as he usually does when chatting with his friends, without thinking about the possible conflicting interpretations of these emojis that might arise as a result of the difference in the sender and receiver profile and sender and receiver context, specifically, their ages and the fact that his grandmother might not be up to date with the popular use of emojis among teenagers of his age.

In this example, using the techniques described above, flagged emojis in the original text are replaced with more appropriate and/or relevant replacement emojis. The message 1002 is now less likely to contain emojis that might cause Gwen to misinterpret what Adam originally intended to say.

Embodiments of the disclosure may include an additional reference module whereby records of the modifications made to emojis are stored over time, e.g., according to their context. The reference module may also store reasons for emoji modifications. The reference module may be provided, for instance, by the database 150 of the system 110 of FIG. 2 or by a separate functional module, as indicated in dotted lines by block 180 in FIG. 2. This may allow an individual to refer to the modifications, e.g., by accessing them using a mobile application, and be advised which emoji to select based on a communication history. This feature may be accessed when needed by a user to cross-reference how emojis where modified and/or learn reasons for modifications.

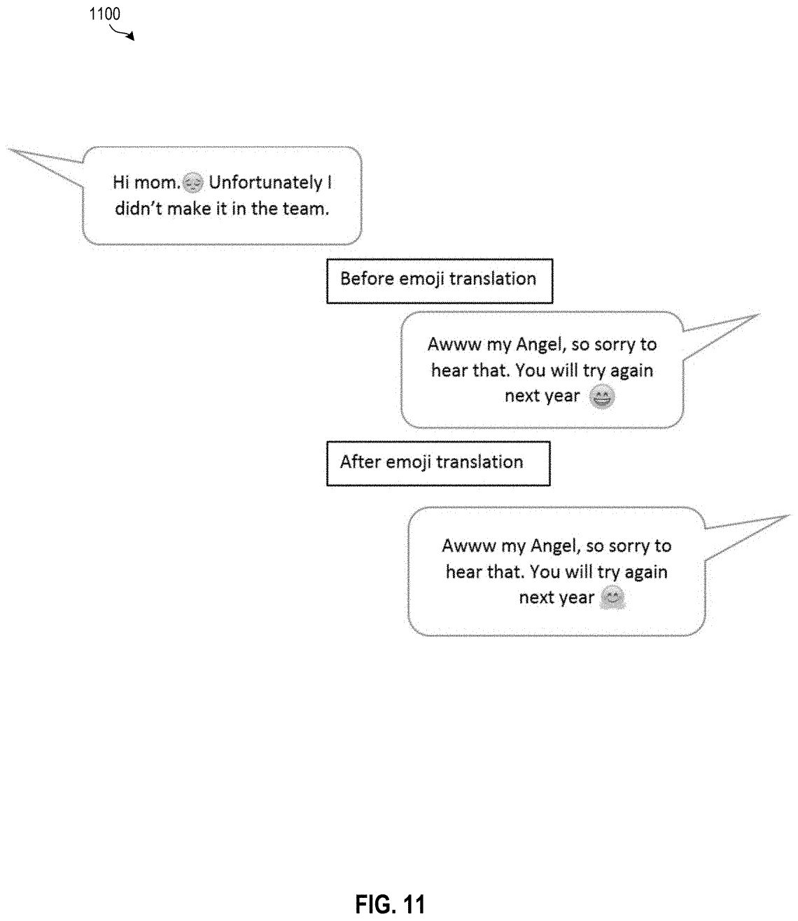

The reference module may store a list of the modifications used, together with the reasoning factors for the specific alterations that occurred. Referring to the example screenshot 1100 of FIG. 11, for example, a parent may be trying to cheer up their daughter, who is disappointed because she was not selected to join a sports team, by sending them a message with a smiling emoji. After the computer system 110 had determined the degree of sentiment and emotional state of the sender and the receiver, the smiling emoji may be translated to the hugging emoji. The message before and after modification are both shown on the sender's user interface and the modification of the smiling emoji to the hugging emoji may be stored for future reference.

In the example above, the smiling emoji may be translated to a hugging emoji to express that the mother means well by comforting her daughter. The smiling face could be interpreted as though the mother was laughing at the daughter's misfortune.

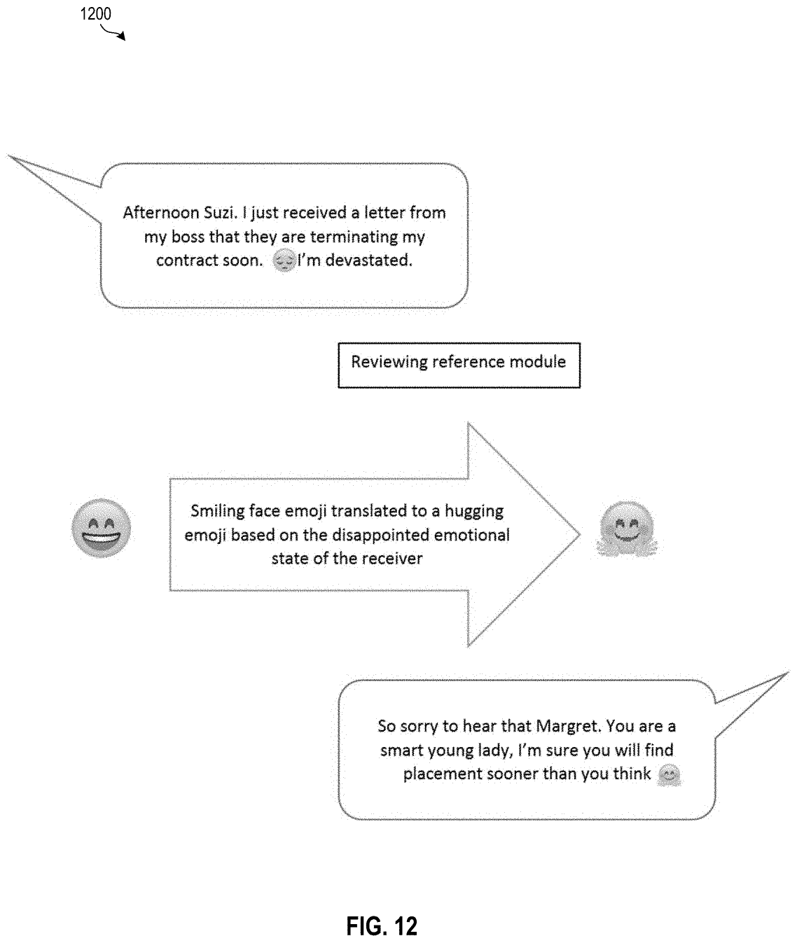

Subsequently, where a friend may express that they are sad or disappointed about an ordeal they have experienced, the mother may use the reference module to determine which emoji to use based on communication history. This is illustrated by the example screenshot 1200 of FIG. 12.

Embodiments of the disclosure may provide an option to send the modified emoji together with a sound clip. Furthermore, the modified emoji maybe converted to a word or words that have the same meaning in a language that matches the receiver's language.

Referring to the example in FIG. 12, if the receiver's first language is English, a “Hugs” sound clip may be made available to send along with the modified emoji. This feature may emphasize the message that is being sent to the receiver.

In some embodiments, the intended meaning of the sender emoji may be queried by a receiver using an interactive emoji query interface. The computer system 110 may be configured to receive a receiver query from the sender device 122 and/or to receive a sender query from the receiver device 132. The computer system 110 may include a receiving module 160 configured for this purpose, as shown in dotted lines in FIG. 2. The computer system 110 may also include a transmitting module 170 configured for transmitting responses to such queries, as shown in dotted lines in FIG. 2.

In response to a sender query, the receiver 130 may receive a response with context and/or profile information about the sender, and/or the intended meaning as inferred by the system. Similarly, the predicted interpretation of the receiver may be queried by the sender 120 using an interactive emoji query interface. The system may respond with context and/or profile information about the receiver, and/or the interpretation as predicted by the system. The interface may make use of NLP. A query may conveniently be transmitted by the sender prior to actually sending a message, thereby avoiding misinterpretation.

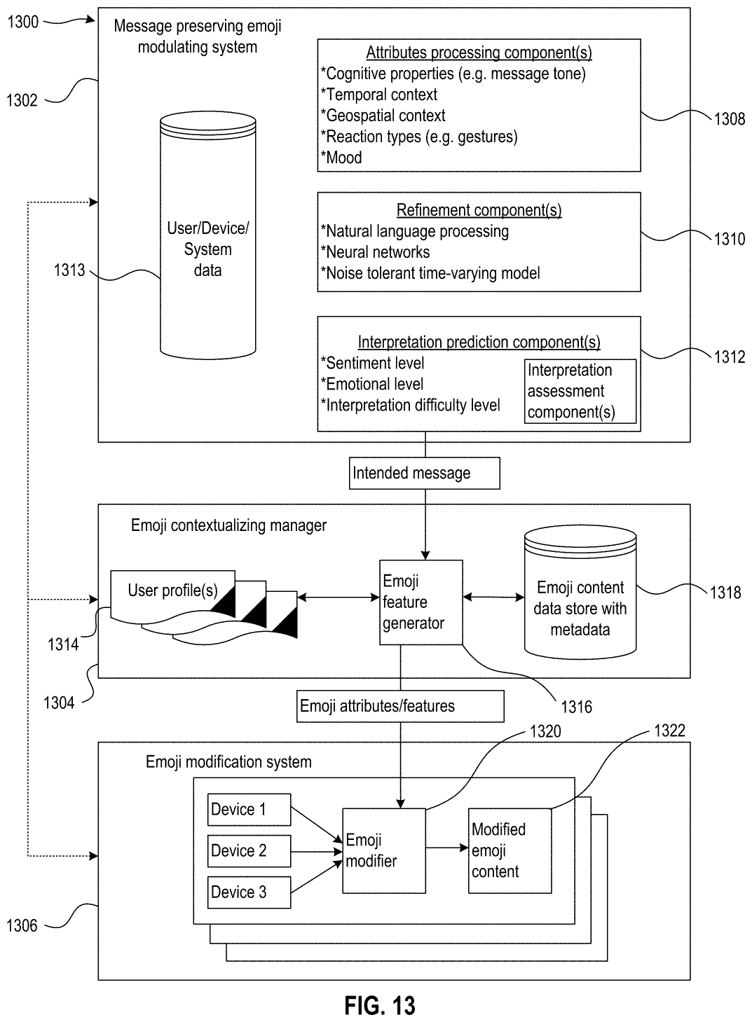

The diagram 1300 of FIG. 13 illustrates a schematic view of functional components of specific examples of a computer system 1302, emoji contextualizing manager 1304 and emoji modification system 1306, which may be utilized in embodiments of the disclosure. The systems 1302, 1306 and manager 1304 include some of the features and components referred to above.

The computer system 1302 may be in the form of a “message preserving emoji modulating system”, functioning in a manner similar to some of the components of the system 110 of FIG. 2. The system 1302 may include an attributes processing system 1308, refinement components 1310 and interpretation prediction components 1312. The system 1302 may further include a database 1313 storing user/device/system data.

The emoji contextualizing manager 1304 may store a plurality of user profiles 1314 and may include an emoji feature generator 1316 and/or an emoji content data store 1318.

The emoji modification system 1306 may function in a manner similar to the emoji modification module 118 of FIG. 2, and may include an emoji modifier 1320 which receives device input and returns modified emoji content 1322.

The system 1302, manager 1304 and system 1306 may provide a so-called trans-vendor service, which may run across messaging applications (e.g., WhatsApp™, Facebook Messenger™, WeChat™, Skype™, Viber™, Telegram™, Snapchat™, SMS, etc), social media applications (e.g., Facebook™, LinkedIn™), email systems, computing devices and/or communication devices. The service may be automatically triggered and run “in the background” when an electronic text-based conversation between parties on respective devices starts, or may triggered if the insertion of an emoji is detected or based on user-specified rules. Conversations may be monitored in real-time to analyze, detect and/or predict various aspects of the sender/receiver as described herein, detect or predict sentiment, emotional level or difficulty of interpreting the intended meaning of emojis.

In the examples given above, the method is carried out between one human sender and one human receiver. However, in other embodiments, a sender may send a message to a plurality of receivers, in which case each receiver's message may be handled separately in the manner described herein.

One application of embodiments of the disclosure may be direct messenger systems (e.g., WhatsApp™, Facebook Messenger™, SMS, email, etc.), wherein communication often involves one sender and one receiver. However, in some embodiments the techniques described herein may be applied where the message is broadcast to many receivers. For example, consider a website which may be viewed by millions of people, across many different locations, cultures, age groups, and the like. In such a scenario, the emoji selected by one sender may need to be rendered differently for each receiver.

The sender and/or receiver may also be non-human, e.g., an Artificial Intelligence (AI) agent or robot. The sender may be a multi-agent team. Furthermore, embodiments of the disclosure may allow for a class of “emoji senders” taking the form of AI agents or robots to send or post emojis for a human user(s). Such an AI agent may be configured with social networking applications to send or post messages that may contain one or more emojis. The AI agent may learn a user's activity (e.g., message, posts or task completion) and send or post emojis in response to the user activity or as part of providing feedback or appreciation on task completion. Emoji modification as described herein may be carried out in a similar manner in cases where the emoji is sent by a sender AI-agent, based on predicted message interpretation.

In embodiments of the disclosure, a replacement or suggested emoji is not simply looked up in a database. Instead, the intended meaning of the sender may be inferred and the interpretation of the receiver may be predicted. If the intended meaning and the inferred interpretation differ, the emoji is replaced or otherwise modified. In this way, the meaning which the sender associates with an electronic message and emoji may be preserved and correctly conveyed by rendering it differently at the receiver, or by suggesting a different rendering or additional information.

Embodiments of the disclosure consider the sentiment of a message in determining the intended meaning of a sender. For instance, in the message, “That is the funniest thing I have ever heard *face with tears emoji*”, the positive sentiment of the message may be inferred from the words used, resulting in the intended meaning being deemed to be joyous. On the other hand, in the message, “My cat just died *face with tears emoji*”, the negative sentiment of the message may be inferred from the words used, resulting in the intended meaning being deemed to be extreme sadness. As described above, not only may a current message be analysed, a conversation context may be analysed by checking a sequence of messages to facilitate the prediction of the sender's meaning and the receiver's probable interpretation.

In addition, previous user activity may form part of the sender profile/context or receiver profile/context. For instance, if the sender transmits a “sleeping face” emoji during working hours, the meaning may be established as boredom and not as sleeping, based on the sender's typical activities during that time of day and/or day of the week.

In some embodiments, the disclosure may provide for the detection and correction of biases or stereotypes. For instance, if the sender is referring to a “nurse”, they may select the emoji for “female health care worker”. However, this may be seen as potentially problematic and the emoji may be replaced with a gender neutral “face with medical mask” emoji.

In some embodiments, the disclosure may provide for censorship. For instance, if the sender transmits an emoji for a gun and the receiver is a child, the emoji may be replaced with a “censored” emoji or may be changed to a water pistol.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and/or computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In one embodiment, a computer program product for emoji modification may be provided. The computer program product may comprise a computer readable storage medium having stored thereon first, second, third and fourth program instructions. The first program instructions may be executable by a computer processor to cause the computer processor to establish an intended meaning associated with an emoji which has been selected by a sender for transmission to a receiver. The second program instructions may be executable by the computer processor to cause the computer processor to predict an interpretation of the emoji by the receiver. The third program instructions may be executable by the computer processor to cause the computer processor to compare the established intended meaning with the predicted interpretation, wherein the comparison between the established intended meaning and the predicted interpretation is used to determine whether emoji modification is required. The fourth program instructions may be executable by the computer processor to cause the computer processor to modify at least one aspect of the emoji in response to a determination that emoji modification is required, thereby better to align the intended meaning of the sender with the predicted interpretation of the emoji by the receiver.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
establishing, by a sender analysis module, an intended meaning associated with an emoji which has been selected by a sender for transmission to a receiver;
predicting, by a receiver analysis module, an interpretation of the emoji by the receiver;
comparing, by a comparison module, the established intended meaning with the predicted interpretation, wherein the comparison between the established intended meaning and the predicted interpretation is used to determine whether emoji modification is required; and
modifying, by an emoji modification module, at least one aspect of the emoji in response to a determination that emoji modification is required, thereby better to align the intended meaning of the sender with the predicted interpretation of the emoji by the receiver.

2. The method of claim 1, wherein establishing the intended meaning associated with the emoji comprises establishing the intended meaning based on at least one of a sender profile and a sender context.

3. The method of claim 1, wherein establishing the intended meaning associated with the emoji comprises at least one of:
analyzing historical usage of the emoji by the sender;
analyzing text associated with the emoji using natural language processing; or
analyzing a conversation context associated with the sender and the receiver.

4. The method of claim 1, wherein predicting the interpretation of the emoji by the receiver comprises predicting the interpretation based on at least one of a receiver profile and a receiver context.

5. The method of claim 1, wherein predicting the interpretation of the emoji by the receiver comprises at least one of:
predicting or determining difficulty in interpretation, by the receiver, of the intended meaning;
predicting or determining a degree of sentiment or emotional level associated with the receiver; or
analyzing a conversation context associated with the sender and the receiver.

6. The method of claim 1, wherein predicting the interpretation of the emoji by the receiver comprises at least one of:
learning or obtaining historical usage and/or interpretation of the emoji by at least one of the sender, the receiver and a cohort of users;
learning or obtaining historical cognitive properties, in response to the emoji, by at least one of the sender, the receiver and a cohort of users;
analyzing, aggregating or obtaining feedback provided for the emoji by at least one of the sender, the receiver and a cohort of users; and
learning or obtaining patterns of historical responses to or interactions with the emoji by at least one of the sender, the receiver and a cohort of users.

7. The method of claim 1, wherein modifying at least one aspect of the emoji comprises at least one of:
substituting the emoji with a more appropriate emoji;
suggesting at least one substitute emoji;
changing one or more features of the emoji;
suggesting changes to one or more features of the emoji;
replacing one or more features of the emoji with more suitable features;
suggesting replacement of one or more features of the emoji with more suitable features;
morphing the emoji;
suggesting morphing of the emoji;
generating or providing an interpretation hint for the emoji;
changing an emoji sequence associated with the emoji; or
suggesting a change in an emoji sequence associated with the emoji.

8. The method of claim 1, wherein predicting the interpretation of the emoji by the receiver comprises determining that an aspect of a sender device associated with the sender differs from an aspect of a receiver device associated with the receiver in terms of at least one of a device type and a messaging or operating platform, wherein the established intended meaning and the predicted interpretation differ at least partially as a result of the difference between the sender device and the receiver device.

9. The method of claim 1, further comprising:
receiving, from a sender device associated with the sender, a receiver query, and in response to receiving the receiver query, transmitting, to the sender device, a response which includes at least one of receiver profile information, receiver context information and the predicted interpretation; or
receiving, from a receiver device associated with the receiver, a sender query, and in response to receiving the sender query, transmitting, to the receiver device, a response which includes at least one of sender profile information, sender context information and the established intended meaning.

10. The method of claim 1, wherein the sender is non-human.

11. The method of claim 1, further comprising:
after the modification of at least one aspect of the emoji, storing, by a reference module, a record of the modification; and
permitting at least the sender to access the record of the modification.

12. A system comprising:
at least one computer processor; and
at least one computer readable storage medium having stored thereon program instructions executable by the at least one computer processor to direct operation of the at least one computer processor, wherein the at least one computer processor, when executing the program instructions, comprises:
a sender analysis module configured to establish an intended meaning associated with an emoji which has been selected by a sender for transmission to a receiver;
a receiver analysis module configured to predict an interpretation of the emoji by the receiver;
a comparison module configured to compare the established intended meaning with the predicted interpretation, wherein the comparison between the established intended meaning and the predicted interpretation is used to determine whether emoji modification is required; and
an emoji modification module configured to modify at least one aspect of the emoji in response to a determination that emoji modification is required, thereby better to align the intended meaning of the sender with the predicted interpretation of the emoji by the receiver.

13. The system of claim 12, the sender analysis module is configured to establish the intended meaning associated with the emoji based on at least one of a sender profile and a sender context.

14. The system of claim 12, wherein the sender analysis module is configured to establish the intended meaning associated with the emoji using at least one of:
analysis of historical usage of the emoji by the sender;
analysis of text associated with the emoji using natural language processing; or
analysis of a conversation context associated with the sender and the receiver.

15. The system of claim 12, wherein the receiver analysis module is configured to predict the interpretation of the emoji by the receiver based on at least one of a receiver profile and a receiver context.

16. The system of claim 12, wherein the receiver analysis module is configured to predict the interpretation of the emoji by the receiver using at least one of:
prediction or determination of difficulty in interpretation, by the receiver, of the intended meaning;
prediction or determination of a degree of sentiment or emotional level associated with the receiver; and
analysis of a conversation context associated with the sender and the receiver.

17. The system of claim 12, wherein the receiver analysis module is configured to predict the interpretation of the emoji by the receiver by determining that an aspect of a sender device associated with the sender differs from an aspect of a receiver device associated with the receiver in terms of at least one of a device type and a messaging or operating platform, wherein the established intended meaning and the predicted interpretation differ at least partially as a result of the difference between the sender device and the receiver device.

18. The system of claim 12, wherein the at least one computer processor, when executing the program instructions, further comprises:
a receiving module and a transmitting module, wherein the receiving module is configured to receive, from a sender device associated with the sender, a receiver query, and wherein the transmitting module is configured to transmit, in response to the receiving module receiving the receiver query, to the sender device, a response which includes at least one of receiver profile information, receiver context information and the predicted interpretation; or
a receiving module and a transmitting module, wherein the receiving module is configured to receive, from a receiver device associated with the receiver, a sender query, and wherein the transmitting module is configured to transmit, in response to the receiving module receiving the sender query, to the receiver device, a response which includes at least one of sender profile information, sender context information and the established intended meaning.

19. The system of claim 12, wherein the at least one computer processor, when executing the program instructions, further comprises a reference module which is configured:
to store a record of modification after the modification of at least one aspect of the emoji; and
to permit at least the sender to access the record of the modification.

20. A computer program product for emoji modification, the computer program product comprising:
a computer readable storage medium having stored thereon:
first program instructions executable by a computer processor to cause the computer processor to establish an intended meaning associated with an emoji which has been selected by a sender for transmission to a receiver; and
second program instructions executable by the computer processor to cause the computer processor to predict an interpretation of the emoji by the receiver;
third program instructions executable by the computer processor to cause the computer processor to compare the established intended meaning with the predicted interpretation, wherein the comparison between the established intended meaning and the predicted interpretation is used to determine whether emoji modification is required; and
fourth program instructions executable by the computer processor to cause the computer processor to modify at least one aspect of the emoji in response to a determination that emoji modification is required, thereby better to align the intended meaning of the sender with the predicted interpretation of the emoji by the receiver.
